(19) United States
(12) Patent Application Publication
(10) Pub. No.: US 2024/0375431 A1
(43) Pub. Date: Nov. 14, 2024

(54) RIM FOR A WHEEL

(71) Applicant: Dymag Group Limited, Chippenham (GB)

(72) Inventors: Eric Wakeman, Chippenham (GB); Thomas De Lange, Chippenham (GB); Michael Wilson, Chippenham (GB)

(21) Appl. No.: 18/291,383

(22) PCT Filed: Dec. 20, 2021
(86) PCT No.: PCT/GB2021/053371

§ 371 Date: Jan. 23, 2024

(30) Foreign Application Priority Data
Jul. 23, 2021 (GB) 2110639.8

(51) Int. Cl. B60B 21/04; B60B 5/02

(52) U.S. Cl. CPC B60B 21/04; B60B 5/02; B60B 2310/204; B60B 2360/3416; B60B 2900/311

(57) ABSTRACT

Herein is disclosed a rim for a wheel. the rim comprising a barrel having first and second flanges extending radially outward from opposing edges of the barrel. and the barrel comprising a first bead seat and a second bead seat arranged axially inwardly. respectively. of the first and second flanges, wherein the barrel, and first and second flanges. comprise layers of structural fibres bound in a polymer matrix, wherein a pre-form insert is disposed between layers of the structural fibres. wherein the insert comprises a material which acts to absorb and/or deflect and/or dissipate energy from a load or impact applied axially and/or radially to a rim and/or acts to increase the hoop stiffness of the wheel and wherein the insert has, when viewed in cross-section (with the axis of the rim being parallel to the plane of the cross-section). two elongate portions. with a first elongate portion of the insert extending into one of the first or second flanges. and a second elongate portion of the insert extending underneath the first or second bead seat, respectively, such that first and second portions together form an approximate ‘L’ shape in cross-section.

### FIELD OF INVENTION

This application relates to wheels, particularly wheels having a non-metallic rim, such as a rim comprising fibre composite and/or plastic materials. The rims and wheels described herein may, for example, be for use with motorised and non-motorised vehicles such as automobiles, motorcycles, bicycles and aircraft etc.

### BACKGROUND

Wheels made from composite materials, such as fibre-reinforced plastics, have made major advances in recent years. However, even recent designs can have certain drawbacks. For example, some wheels that experience very high and/or sudden axial or radial loads or impacts can experience a loss in the structural integrity of the wheel, which can lead to tire deflation and/or a loss of control of a vehicle. This is particularly a concern for automobiles and motorbikes that experience high speeds. Additionally structural damage to a rim can mean the entire rim needs to be replaced, for safety reasons, owing to the difficulty of accurate damage assessment and the lack of easily replaceable elements, rather than simply being repaired. Sometimes, damage can go undetected on rims, which can be a safety problem if the wheels are used on, and then fail on, a vehicle.

The applicant made an advance in the field, as described in WO2017/046555, where one or more inserts were included in a wheel, with their positioning relative to a primary structural component and other parts of the wheel being important. The wheel described in this publication were found to be superior in the SAEJ328 test, compared to wheels without inserts. A particularly effective embodiment was one having two inserts on each side of the rim—one extending into an upstanding flange, and the other under the bead seat, with the primary load path passing between them. The present inventors sought to develop an improvement to this wheel, which had improved ease of manufacture, yet would perform at least comparably well in mechanical tests, such as the SAEJ328 test, a cornering fatigue test, a 13 Degree Impact test, an inner rim impact test, and a 90 degree rim impact test.

### SUMMARY OF THE INVENTION

In a first aspect, there is provided a rim for a wheel, the rim comprising
a barrel having first and second flanges extending radially outward from opposing edges of the barrel, and the barrel comprising a first bead seat and a second bead seat arranged axially inwardly, respectively, of the first and second flanges,
wherein the barrel, and first and second flanges, comprise layers of structural fibres bound in a polymer matrix,
wherein a pre-formed insert is disposed between layers of the structural fibres, wherein the insert comprises a material which acts to absorb and/or deflect and/or dissipate energy from a load or impact applied axially and/or radially to a rim and/or acts to increase the hoop stiffness of the wheel and wherein the insert has, when viewed in cross-section (with the axis of the rim being parallel to the plane of the cross-section), two elongate portions, with a first elongate portion of the insert extending into one of the first or second flanges, and a second elongate portion of the insert extending underneath the first or second bead seat, respectively, such that first and second portions together form an approximate ‘L’ shape in cross-section.

In a second aspect, there is provided a wheel comprising a rim of the first aspect.

In a third aspect, there is provided a vehicle comprising a wheel of the second aspect.

In a fourth aspect, there is provided a method for making a rim of the first aspect, the method comprising assembling the structural fibres and the pre-formed insert, and binding them together by the polymer matrix, to form the rim described in the first aspect.

The typical design of a prior art rim of a composite wheel is a barrel having two flanges extending radially outward from opposing edges of the barrel. The barrel is generally cylindrical. Bead seats are normally arranged axially inwardly of the barrel. The bead seats are surfaces on which the inner rims of a tyre seat onto the wheel. The flanges prevent lateral (i.e. axial) movement of the tyre on the wheel. Generally, commercially available composite wheels have a rim that is integrally formed and contoured to form the flanges, the bead seats and the section of the barrel between the bead seats. The present inventors found that the transfer of sudden and/or high loads through the bead seat can be one of the causes of a loss in the structural integrity of a wheel. Embodiments of rims described herein reduce the propensity of a composite wheel to suffer from damage from sudden and/or high axial and/or radial loads, while still having a lightweight structure and desired properties that allows their use in high performance situations, in vehicles or aircraft. They are also easier and more cost-effective to manufacture than some prior art rims, while still having comparable performance in mechanical tests. It has also been found that, owing the design of the rim, there are advantages in the way in which it can be constructed, compared to a rim that, for example, has two inserts in/near each flange, e.g. as described in WO2017/046555. The new rims with the inserts described herein are faster to lay-up and, when constructing them manually, the human operatives require less training. This also means the rims can be constructed in an automated process more easily. It was also found that the resin that forms the polymer matrix injects more quickly and consistently into the layers of structural fibres-this leads to fewer problems when mass producing the rims, in terms of quality. There are also fewer problems with surface porosity on the tyre mounting surface and significantly less surface finishing work prior to lacquer in the rims described herein, compared to those described in WO2017/046555. The new rims described herein have also been found to perform better in a 90 degree (radial) load test than those with two inserts, i.e. as described in described in WO2017/046555.

### BRIEF DESCRIPTION OF THE FIGURES

FIG. 1A shows a cross sectional view of an embodiment of the rim disclosed herein for use in a wheel on a four-wheeled vehicle.

FIG. 1B shows a close-up of the outboard flange of the rim of FIG. 1A.

FIG. 2 shows a comparative rim having two inserts in/close to each flange, as described in more detail below in the Examples.

FIG. 3A shows, schematically, a triaxial fabric for use in the rim, when viewed from a radial direction, with one of the axes of the fibres of the fabric being parallel to the axial direction, i.e. running along a flange-to-flange direction (A-from the first flange to the second flange).

FIG. 3B shows, schematically, a biaxial fabric for use in the rim, e.g. in the outer layer, when viewed from a radial direction, with neither of the axes of the fibres of the fabric being parallel to the axial direction, i.e. running along a flange-to-flange direction (from the first flange to the second flange). Each axis of the fabric is at an angle of about 45° to the flange-to-flange direction (or axial direction A).

FIG. 4 shows a wheel comprising a rim (which may be as described herein) and a centrepiece. The interior components of the rim are not shown in this Figure for clarity.

FIG. 5 shows schematically the test equipment for a radial load test, including a drum and a wheel to be tested.

FIGS. 6A and 6B show schematically the test equipment for a 90 degree (radial) impact test (FIG. 6A showing the equipment perpendicular to the axis of the wheel; FIG. 6B showing the equipment along the axis of the wheel). The test equipment comprises an angled fixture onto which the test wheel is mounted with the tyre touching the ground; a drop mass is released from a set height to impart impact energy into the tyre side of the rim.

FIGS. 7A and 7B show schematically the equipment for use in a 13 degree (lateral) impact test. The test equipment comprises an angled fixture onto which the test wheel is mounted. A drop mass is released from a set height to impart impact energy into the side of the rim as shown in FIGS. 7A (showing a cross-section of the wheel) and 7B (shown at 90 degrees from FIG. 7A, i.e. from right hand side of FIG. 7A).

### DETAILED DESCRIPTION

### Structural Fibres and Polymer Matrix

The barrel, and first and second flanges, comprise layers of structural fibres bound in a polymer matrix.

Optionally at least some of the structural fibres extend in a direction from the first flange along an axis defined by the rim, when viewed from a radial direction. As described herein, if fibres extend along or are parallel to a particular direction, the fibres may be at an angle not greater than 20° from that direction, optionally at an angle not greater than 5 15° from that direction, optionally at an angle not greater than 10° from that direction, optionally at an angle not greater than 5° from that direction, optionally at an angle not greater than 3° from that direction, optionally at an angle not greater than 1° from that direction, optionally exactly parallel to that direction.

The structural fibres may be selected from carbon, aramid and glass fibres.

In an embodiment the structural fibres form a fabric. The structural fibres may have been woven, knitted, stitched, braided, wound, stapled or otherwise bound into a fabric. In an embodiment, the structural fibres may have been bound by other fibres and/or a polymer (before being bound by the polymer matrix to form the rim). At least some of the structural fibres may be aligned with one another, e.g. in a biaxial or triaxial fabric, or may be randomly orientated with respect to one another. Preferably at least some of the fibres are aligned with one another, e.g. in a biaxial or triaxial fabric, and, preferably, at least some of the fibres are orientated in a flange-to-flange direction (as will be described in more detail below). The structural fibres may have been formed into a 3D (three-dimensional) material, e.g. a material in which the fibres are orientated in three dimensions, e.g. formed in a 3D weaving process or a 3D braiding process.

In an embodiment, the structural fibres are in the form of biaxial or tri-axial fabric. The biaxial or tri-axial fabric may be woven or may be in the form of non-crimp fabrics. Non-crimp fabrics are ones having structural fibres running in two or three different directions (depending on whether they are biaxial or triaxial, respectively), but the structural fibres running in different directions are not woven together, but instead form different layers in the fabric, with each layer bound together by stitching with a third fibre, adhesive or other means. A biaxial fabric may be defined herein as a fabric having two sets of fibres, with each set being disposed or oriented at an angle to each other, which may be at an angle of 90° to 140 to one another,. A tri-axial fabric may be defined herein as a fabric having three sets of fibres, with each set in a different orientation to one of the other sets, e.g. a first set at 0°, a second set at +60° to the first set and a third set at −60° to the first set. The triaxial fabric may comprise structural fibres orientated in three directions, as described herein, and may optionally further include further fibres, e.g. structural fibres, in a fourth direction, which may be woven in with or sewn into the other fibres. This can aid the manufacturing process.

In an embodiment, at least some of the structural fibres extend through the barrel in a direction substantially parallel to an axis defined by the rim.

In an embodiment, at least one of the layers of structural fibres in the barrel, and first and second flanges comprises a triaxial fabric or a biaxial fabric. The biaxial fabric and triaxial fabric described herein are preferably formed from carbon fibres.

In an embodiment, a filling component is disposed in the rim, e.g. in the first flange and/or second flange and/or under the first and/or second bead seat, the filling component running at least part way around the circumference of the rim in the first flange and/or second flange, respectively. In an embodiment, a filling component is disposed adjacent the insert, at a location that the layers of structural fibres above the insert in barrel meet the layers of fibres below the insert in the barrel, with the filling component running at least part way around the circumference of the rim; however, as described herein, the use of moulded foam inserts and triaxial fibres in the bead seat has lessened the propensity for resin build-up in this area, and hence lessened the need for the filling component.

In an embodiment, a filling component is disposed adjacent the end of the first elongate portion of the insert, this end being the end disposed radially furthest from the axis of the rim.

In an embodiment, a filling component is disposed in the third flange, the filling component running at least part way around the circumference of the rim in the third flange.

In an embodiment, the filling component comprises a substantially unidirectional fibrous material extending in a circumferential direction around the rim. The fibrous material may be entwined together, e.g. braided together, and may form a rope. The fibrous material may comprise structural fibres, which may or may not be the same type of structural fibres used in the primary structural component or outer layer. The structural fibres in the filling component may comprise fibres selected from carbon, aramid and glass fibres.

The polymer matrix may comprise a polymer selected from a thermoplastic and a thermoset polymer. The polymer matrix may comprise polymer selected from an epoxy resin (EP), a polyester resin (UP), a vinyl ester resin (VE), a polyamide resin (PA), polyether ether ketone (PEEK), bismaleimides (BMI), polyetherimide (PEI) and benzoxazine.

### Balanced Lay-up and Layers of Structural Fibres

In an embodiment, a first plurality of layers of structural fibres form the bead seat above (i.e. radially outward of) the second elongate portion of the insert, and a second plurality of layers of structural fibres are disposed below (i.e. radially inward of) the second elongate portion. Optionally, the ratio of thickness of the first plurality of layers of structural fibres to the second plurality of layers of structural fibres is from about 2:1 to about 1:2, optionally about 3:2 to about 2:3, optionally about 4:3 to about 3:4, optionally about 5:4 to about 4:5. In an embodiment, a second plurality of layers of structural fibres is the of the same or greater thickness than the thickness of the first plurality of layers.

In an embodiment, a first plurality of layers of structural fibres form the bead seat above (i.e. radially outward of) the second elongate portion of the insert and the first plurality of layers each comprise structural fibres running in a direction parallel to an axial direction of the rim, and a second plurality of layers of structural fibres are disposed below (i.e. radially inward of) the second elongate portion and the second plurality of layers each comprises structural fibres running in a direction parallel to an axial direction of the rim. Optionally, the ratio of thickness of the first plurality of layers of structural fibres, with each layer having structural fibres running in a direction parallel to an axial direction of the rim, to the second plurality of layers of structural fibres, with each layer having structural fibres running in a direction parallel to an axial direction of the rim, is from about 2:1 to about 1:2, optionally about 3:2 to about 2:3, optionally about 4:3 to about 3:4, optionally about 5:4 to about 4:5. In an embodiment, a second plurality of layers of structural fibres is the of the same or greater thickness than the thickness of the first plurality of layers.

In an embodiment, a first plurality of layers of structural fibres in the first flange are disposed axially inwardly from the first elongate portion of the insert, and a second plurality of layers of structural fibres in the first flange are disposed axially outwardly of the first elongate portion of the insert extending into one of the first flange, and optionally wherein the ratio of thickness of the first plurality of layers of structural fibres to the second plurality of layers of structural fibres is from about 2:1 to about 1:2, optionally about 3:2 to about 2:3, optionally about 4:3 to about 3:4, optionally about 5:4 to about 4:5. In an embodiment, a second plurality of layers of structural fibres in the flange is the of the same or greater thickness than the thickness of the first plurality of layers in the flange.

In an embodiment, a first plurality of layers of structural fibres in the first flange are disposed axially inwardly from the first elongate portion of the insert and the first plurality of layers each comprise structural fibres running in a direction parallel to an axial direction of the rim, and a second plurality of layers of structural fibres in the first flange are disposed axially outwardly of the first elongate portion of the insert extending into one of the first flange and the second plurality of layers each comprise structural fibres running in a direction parallel to an axial direction of the rim, and optionally wherein the ratio of thickness of the first plurality of layers of structural fibres, with each layer having structural fibres running in a direction parallel to an axial direction of the rim, to the second plurality of layers of structural fibres, with each layer having structural fibres running in a direction parallel to an axial direction of the rim, is from about 2:1 to about 1:2, optionally about 3:2 to about 2:3, optionally about 4:3 to about 3:4, optionally about 5:4 to about 4:5. In an embodiment, a second plurality of layers of structural fibres in the flange is the of the same or greater thickness than the thickness of the first plurality of layers in the flange.

In an embodiment, a first plurality of layers of structural fibres in the second flange are disposed axially inwardly from the first elongate portion of the insert, and a second plurality of layers of structural fibres in the first flange are disposed axially outwardly of the first elongate portion of the insert extending into one of the second flange, and optionally wherein the ratio of thickness of the first plurality of layers of structural fibres to the second plurality of layers of structural fibres is from about 2:1 to about 1:2, optionally about 3:2 to about 2:3, optionally about 4:3 to about 3:4, optionally about 5:4 to about 4:5. In an embodiment, a second plurality of layers of structural fibres in the second flange is the of the same or greater thickness than the thickness of the first plurality of layers in the second flange.

In an embodiment, a first plurality of layers of structural fibres form the bead seat above (i.e. radially outward of) the second elongate portion of the insert and the first plurality of layers extend along the barrel and into the second flange (optionally each of these layers comprise structural fibres running in a direction parallel to an axial direction of the rim and/or are triaxial fabrics), and a second plurality of layers of structural fibres are disposed below (i.e. radially inward of) the second elongate portion and the second plurality of layers extend along the barrel and into the second flange (and optionally each of these layers comprises structural fibres running in a direction parallel to an axial direction of the rim and/or are triaxial fabrics). Optionally, the ratio of thickness of the first plurality of layers of structural fibres, with each layer having structural fibres running in a direction parallel to an axial direction of the rim, to the second plurality of layers of structural fibres, with each layer having structural fibres running in a direction parallel to an axial direction of the rim, is from about 2:1 to about 1:2, optionally about 3:2 to about 2:3, optionally about 4:3 to about 3:4, optionally about 5:4 to about 4:5. In an embodiment, a second plurality of layers of structural fibres is the of the same or greater thickness than the thickness of the first plurality of layers.

In an embodiment, a first plurality of layers of structural fibres in the first flange are disposed axially inwardly from the first elongate portion of the insert in the first flange and the first plurality of layers each extend along the barrel and into the second flange (optionally each of these layers comprise structural fibres running in a direction parallel to an axial direction of the rim and/or are triaxial fabrics), and a second plurality of layers of structural fibres in the first flange are disposed axially outwardly of the first elongate portion of the insert extending into the first flange and the second plurality of layers each extend along the barrel and into the second flange (optionally each of these layers comprise structural fibres running in a direction parallel to an axial direction of the rim and/or are triaxial fabrics), and optionally wherein the ratio of thickness of the first plurality of layers of structural fibres, with each layer having structural fibres running in a direction parallel to an axial direction of the rim, to the second plurality of layers of structural fibres, with each layer having structural fibres running in a direction parallel to an axial direction of the rim, is from about 2:1 to about 1:2, optionally about 3:2 to about 2:3, optionally about 4:3 to about 3:4, optionally about 5:4 to about 4:5. In an embodiment, a second plurality of layers of structural fibres in the flange is the of the same or greater thickness than the thickness of the first plurality of layers in the flange.

In an embodiment, a first plurality of layers of structural fibres form the bead seat above (i.e. radially outward of) the second elongate portion of the insert in the second flange and the first plurality of layers extend along the barrel and into the first flange (optionally each of these layers comprise structural fibres running in a direction parallel to an axial direction of the rim and/or are triaxial fabrics), and a second plurality of layers of structural fibres are disposed below (i.e. radially inward of) the second elongate portion of the insert in the second in the second flange and the second plurality of layers extend along the barrel and into the first flange (and optionally each of these layers comprises structural fibres running in a direction parallel to an axial direction of the rim and/or are triaxial fabrics). Optionally, the ratio of thickness of the first plurality of layers of structural fibres, with each layer having structural fibres running in a direction parallel to an axial direction of the rim, to the second plurality of layers of structural fibres, with each layer having structural fibres running in a direction parallel to an axial direction of the rim, is from about 2:1 to about 1:2, optionally about 3:2 to about 2:3, optionally about 4:3 to about 3:4, optionally about 5:4 to about 4:5. In an embodiment, a second plurality of layers of structural fibres is the of the same or greater thickness than the thickness of the first plurality of layers.

In any of the embodiments above, the ratio of the first plurality of layers to the second plurality of layers in the first flange may be substantially the same as the ratio of the first plurality of layers to the second plurality of layers in the second flange. “Substantially the same” indicates that they differ by less than 20%, optionally less than 10%, optionally less than 5%.

Preferably, at least one layer of structural fibres, preferably at least two layers of structural fibres (and preferably with each layer having structural fibres running in a direction parallel to an axial direction of the rim) extend(s) at least partially along one side of the first insert, all the way along the barrel and at least partially along one side of the second insert (if present). Preferably, at least one layer of structural fibres, preferably at least two layers of structural fibres (and preferably with each layer having structural fibres running in a direction parallel to an axial direction of the rim), extend at least partially along the radially outward side of the first insert, all the way along barrel and at least partially along the radially outward side of the second insert (if present). Preferably, at least one layer of structural fibres, preferably at least two layers of structural fibres (with preferably each layer having structural fibres running in a direction parallel to an axial direction of the rim), extend at least partially along the radially inward side of the first insert, all the way along barrel and at least partially along the radially inward side of the second insert (if present).

Preferably, at least two layers of structural fibres, each layer having structural fibres running in a direction parallel to an axial direction of the rim and optionally being a triaxial fabric, extend at least partially along one side of the first insert, all the way along the barrel and at least partially along one side of the second insert (if present). Preferably, at least one, preferably at least two layers of structural fibres, each layer having structural fibres running in a direction parallel to an axial direction of the rim and optionally being a triaxial fabric, extend at least partially along the radially outward side of the first insert, all the way along barrel and at least partially along the radially outward side of the second insert (if present). Preferably, at least one, preferably at least two layers of structural fibres, each layer having structural fibres running in a direction parallel to an axial direction of the rim and optionally being a triaxial fabric, extend at least partially along the radially inward side of the first insert, all the way along barrel and at least partially along the radially inward side of the second insert (if present).

### Material of the Insert(s)

The insert is pre-formed, which indicates that the insert had been formed before the insert, structural fibres and polymer matrix were bound together, e.g. by the setting of the polymer matrix, to form the rim. The insert comprises a material which acts to absorb and/or deflect and/or dissipate energy from a load or impact applied axially and/or radially to a rim and/or acts to increase the hoop stiffness of the wheel. The material of the insert may be different from that of the structural fibres and/or that of the polymer matrix. Preferably the insert has a continuous, i.e. non-porous, surface over substantially the entire outer surface of the insert.

In an embodiment, the pre-formed insert comprises or consists of a material selected from a compressible material, an elastomeric material and a foamed material. The material may be a cellular, elastomeric material. The material may be a cellular, compressible material. The cellular material may be selected from a honeycomb and a foam. The cellular material may be an open-celled material or a closed-cell material, e.g. an open-celled foam or a closed-cell foam. A closed-cell material has been found to be more effective. If the material is a cellular material, preferably the material has a continuous, i.e. non-porous, surface over substantially the entire outer surface of the insert, such that the cells are closed by the continuous surface.

The foamed material may be formed in the desired shape in a variety of ways, including, but not limited to, using tools to fashion a pre-existing foamed material into the desired shape or foaming the material in a mould that is of the desired shape. The material may be a compression moulded material. Preferably, the foamed material is an injection-moulded foam material. Using injection-moulded foams, such as injection-moulded polyurethane, has been found to be particularly effective in producing a wheel efficiently (e.g. on energy, cost and time considerations) that still performs well in tests. Preferably, the foam has a skin on it formed from the moulding process. A skin in this context is a continuous layer of the material of the insert extending over and closing at least some of the cellular portions of the foam; optionally at least 90% of the surface area of the moulded insert has a skin on it, optionally at least 95% of the surface area of the moulded insert has a skin on it, optionally at least 99% of the surface area of the moulded insert has a skin on it, optionally all of the surface area of the moulded insert has a skin on it. This has been found, particularly when the moulded insert follows the contour of the safety bead, to avoid the build-up of resin in certain parts of the rim, improving structural integrity of the rim during mechanical tests; it also assists with improving the rigidity of the insert and the rim.

The insert may comprise a polymeric material, which may be a cellular polymeric material, e.g. a polymeric foam or a polymeric honeycomb. The foam may be an open- or closed-cell foam. The foam may comprise a foamed polymer, which may be selected from a foamed polyacrylamide, such as polymethylacrylimide, a foamed polyurethane, a foamed polystyrene, a foamed vinyl chloride, a foamed acrylic polymer, a foamed polyethylene, a foamed polypropylene, a foamed polycarbonate and a foamed vinyl nitrile, such as an acrylonitrile-butadiene-styrene (ABS) co-polymer. In an embodiment, the protective insert comprises an elastomeric polymer, such as rubber, which may be a synthetic rubber, such as styrene butadiene, or natural rubber. The elastomeric polymer may or may not be foamed.

The insert may extend at least part way, optionally all the way, circumferentially, around the rim. In an embodiment, a plurality of inserts extend circumferentially, around the rim, and together form a ring.

The protective insert may have a density, as measured by BS4370 or ASTM D 1622, of at least 10 kg/m³, optionally at least 20 kg/m³, optionally at least 30 kg/m³, optionally at least 40 kg/m³, optionally at least 100 kg/m³, optionally at least 150 kg/m³, optionally at least 200 kg/m³. The protective insert may have a density, as measured by BS4370 or ASTM D 1622, of 500 kg/m³ or less, optionally of 400 kg/m³ or less, optionally of 320 kg/m³ or less, optionally 110 kg/m³ or less, optionally 75 kg/m³ or less, optionally 60 kg/m³ or less.

The protective insert may have a density, as measured by BS4370 or ASTM D 1622, of from 10 kg/m³ to 500 kg/m³, optionally from 50 kg/m³ to 500 kg/m³, optionally from 200 kg/m³ to 500 kg/m³, optionally from 200 kg/m³ to 400 kg/m³, optionally from 200 kg/m³ to 400 kg/m³, optionally from 250 kg/m³ to 350 kg/m³. The protective insert may comprise foamed polyurethane, preferably injection-moulded foamed polyurethane, and have a density, as measured by BS4370 or ASTM D 1622, of from 10 kg/m³ to 500 kg/m³, optionally from 50 kg/m³ to 500 kg/m³, optionally from 200 kg/m³ to 500 kg/m³, optionally from 200 kg/m³ to 400 kg/m³, optionally from 200 kg/m³ to 400 kg/m³, optionally from 250 kg/m³ to 350 kg/m³.

The protective insert may have a density, as measured by ASTM D 1622, of from 10 kg/m³ to 120 kg/m³, optionally from 20 kg/m³ to 120 kg/m³, optionally from 30 kg/m³ to 120 kg/m³, optionally from 40 kg/m³ to 80 kg/m³, optionally from 40 kg/m³ to 60 kg/m³, optionally from 40 kg/m³ to 80 kg/m³. The protective insert may comprise foamed polymethacrylimide and have a density, as measured by ASTM D 1622, of from 10 kg/m³to 120 kg/m³, optionally from 20 kg/m³ to 120 kg/m³, optionally from 30 kg/m³ to 120 kg/m³, optionally from 40 kg/m³ to 80 kg/m³, optionally from 40 kg/m³ to 60 kg/m³, optionally from 40 kg/m³ to 80 kg/m³.

optionally from 30 kg/m³ to 120 kg/m³, optionally from 40 kg/m³ to 80 kg/m³, optionally from 40 kg/m³ to 60 kg/m³, optionally from 40 kg/m³ to 80 kg/m³.

The protective insert, which may comprise or be a foamed polyurethane, may have a compressive strength (parallel to rise), as measured according to BS4730, of at least 0.1 kPa, optionally at least 0.2 MPa, optionally at least 0.3 MPa, optionally at least 0.4 MPa, optionally at least 0.5 MPa, optionally at least 0.6 MPa, optionally at least 0.7 MPa, optionally at least 0.8 MPa, optionally at least 0.9 MPa. The protective insert, which may comprise or be a foamed polyurethane, may have a compressive strength, as measured according to ASTM D 1621, of 6 MPa or less, optionally 4 MPa or less, optionally 3 MPa or less, optionally 2 MPa or less, optionally 1.5 MPa or less, optionally 1 MPa or less. The protective insert, which may comprise or be a foamed polyurethane, may have a compressive strength, as measured according to ASTM D 1621, of from 0.1 MPa to 6 MPa, optionally from 1 MPa to 6 MPa, optionally from 2 MPa to 5 MPa, optionally from 3 MPa to 5 MPa, optionally from 3.5 MPa to 4.5 MPa. Suitable foamed polyurethane foam are available commercially.

The protective insert, which may comprise or be a closed-cell polymeth-acrylimide foam, may have a compressive strength, as measured according to ASTM D 1621, of at least 0.1 MPa, optionally at least 0.2 MPa, optionally at least 0.3 MPa, optionally at least 0.4 MPa, optionally at least 0.5 MPa, optionally at least 0.6 MPa, optionally at least 0.7 MPa, optionally at least 0.8 MPa, optionally at least 0.9 MPa. The protective insert, which may comprise or be a closed-cell polymeth-acrylimide foam, may have a compressive strength, as measured according to ASTM D 1621, of 5 MPa or less, optionally 4 MPa or less, optionally 3 MPa or less, optionally 2 MPa or less, optionally 1.5 MPa or less, optionally 1 MPa or less. The protective insert, which may comprise or be a closed-cell polymeth-acrylimide foam, may have a compressive strength, as measured according to ASTM D 1621, of from 0.1 MPa to 5 MPa, optionally from 0.3 MPa to 4 MPa, optionally from 0.4 MPa to 4 MPa, optionally from 0.7 MPa to 3.5 MPa, optionally from 0.7 MPa to 2 MPa, optionally from 0.7 MPa to 1.5 MPa, optionally from 0.7 MPa to 1.3 MPa. Example of foams that may be used for the filler material include closed-cell polymeth-acrylimide foams, which are available from Rohacell®, such as Rohacell® IG and IG-F foams.

The protective insert may comprise a foamed polymer, which may be a foamed polyurethane, and the foamed polymer may have a skin thereon. The skin may have a Shore A hardness of from 80 to 100, optionally from 80 to 100. The skin may have a Shore D hardness of from 20 to 60, optionally from 30 to 50. The Shore A and D hardnesses may be measured at 20° C. and 100,000 Pa.

The protective insert may comprise a foamed polymer, which may be a foamed polyurethane, and the foamed polymer may be a closed cell foamed polymer. A closed cell foamed polymer may be defined as a foam having a closed cell content of at least 80%, optionally at least 90%, optionally at least 95%, optionally at least 98%, as measured using ASTM 0-6226.

In an embodiment, the pre-formed insert comprises or consists of a hollow shell that forms the insert. The hollow shell may be formed from a rigid material, i.e. sufficiently rigid to hold its shape and not deform under its own weight. The material of the hollow shell, e.g. the rigid material, may be selected from a metal or a plastic, optionally wherein the metal is aluminum; the plastic may be selected from a thermoplastic and a thermosetting plastic; the plastic may be selected from polyamides (PA), polycarbonates (PC), polyesters (PES), polyethylene (PE), polypropylene (PP), polyethylene terephthalate (PET), polystyrene (PS), polyurethane (PU), polyvinylchloride (PVC), polyvinylidene chloride (PVDC), and acrylonitrile butadiene styrene (ABS).

Shape/size of the insert(s)

The insert has, when viewed in cross-section (with the axis of the rim being parallel to the plane of the cross-section), two elongate portions, with a first elongate portion of the insert extending into one of the first or second flanges, and a second elongate portion of the insert extending underneath the first or second bead seat, respectively, such that first and second portions together form an approximate ‘L’ shape in cross-section. In an embodiment an insert is located in the first flange and under the first bead seat, such that the first elongate portion of the insert extends into one of the first flanges, and a second elongate portion of the insert extending underneath the first bead seat, respectively. In embodiment an insert is located in the second flange and under the second bead seat, such that the first elongate portion of the insert extends into the second flange, and a second elongate portion of the insert extends underneath the second bead seat. The first and/or second elongate portions of the inert, when viewed in cross-section (with the axis of the rim being parallel to the plane of the cross-section), may each taper to a point. The first elongate portion may have a substantially vertical portion of radially outward face (again when viewed in cross-section), and the radially outward face of the insert below the substantially vertical portion may be curved to the distal end of the second elongate portion (i.e. the part of the insert that is disposed furthest, axially, from the axially outer face of the rim, and to which the second elongate portion may taper).

In an embodiment, the first and second flanges each contain an insert as defined herein, with a first insert having its first elongate portion extending into the first flange and its second elongate portion extending under the first bead seat, and a second insert having its first elongate portion extending into the second flange and its second elongate portion extending under the second bead seat.

In an embodiment, the rim is for a wheel for a four-wheeled vehicle, with the first flange being an outboard flange, when fitted to a vehicle, and the first elongate portion of the insert extending into one of the first flange, and the second elongate portion of the insert extending underneath the first bead seat.

In an embodiment, the second elongate portion extends under the entire bead seat, which may be the first or second bead seat, including the safety bead.

In an embodiment, the first elongate portion extends at least 80%, optionally at least 90%, of the length of the flange in which it is located, the length being measured radially from the bottom of the bead seat (i.e. the structural fibres of the bead seat closest to the insert) to the top of the flange (i.e. the part of the flange located furthest away, radially, from the axis of the rim).

The bead seat is typically the generally flat portion on which a tyre can rest. The safety bead is typically a raised portion (i.e. extending axially from the bead seat) that prevents lateral (i.e. along the axis) movement of a tyre in a direction away from the closest flange.

In an embodiment, the first elongate portion of the insert extends into the first flange, and the second elongate portion of the insert extending underneath the first bead seat, and a first safety bead is located axially inwardly of the first bead seat, and the insert approximately follows the outer contour of the first bead seat and first safety bead.

In an embodiment, the first elongate portion of the insert extends into the second flange, and the second elongate portion of the insert extending underneath the second bead seat, and a second safety bead is located axially inwardly of the second bead seat, and the insert approximately follows the outer contour of the second bead seat and second safety bead.

In an embodiment, one or more layers of structural fibres extend over the top of the first or second flange (with the top of the rim being the part of the rim radially furthest from the axis of the rim), and the thickness of the one or more layers of structural fibres extend over the top of the first or second flange is the same as or preferably less than the thickness of the fibres located axially outwardly of the first elongate portion of the insert. In an embodiment, one or more layers of structural fibres extend over the top of the first or second flange (with the top of the rim being the part of the rim radially furthest from the axis of the rim), and the ratio of thickness of the one or more layers of structural fibres extending over the top of the first or second flange to the thickness of the fibres located axially outwardly of the first elongate portion of the insert is 1: n, wherein n is at least 1, optionally at least 1.5. optionally at least 2, optionally at least 2.2, optionally from 1 to 5, optionally from 1.5 to 5, optionally from 1.5 to 4, optionally from 1.5 to 4.

Third, radially-inwardly extending flange

In an embodiment, the rim comprises a third flange that extends from the barrel radially inwardly (i.e. toward the axis of the rim) and to which wheel attachments, e.g. spokes, may be fitted. Optionally, the third flange is formed by further layers of structural fibres that follow the contours of the third flange and extend along a radially inner side of a barrel on both sides of the third flange, optionally such that it extends along an axially outer edge of a flange, which may be the first flange if the third flange is located on the barrel closer to the first flange than the second flange or may be the second flange if the third flange is located on the barrel closer to the second flange than the first flange. Optionally, the further layers of structural fibres comprise tri-axial fabric.

The third flange may extend part way, optionally all the way, around the circumference of the rim.

The third flange may have one or more apertures extending axially therethrough (i.e. in a direction parallel to the axial direction of the rim), to which spokes may be fitted.

The third flange may have disposed therein one or more filling components, each of which runs at least part way around the circumference of the rim. If a plurality of filling components are present, they may disposed concentrically, with respect to the axis of the rim. In an embodiment, the filling component comprises a substantially unidirectional fibrous material extending in a circumferential direction around the rim. The fibrous material may be entwined together, e.g. braided together, and may form a rope. The fibrous material may comprise structural fibres, which may or may not be the same type of structural fibres used in the barrel, and first and second flanges. The structural fibres in the filling component may comprise fibres selected from carbon, aramid and glass fibres. The filling component may be elongate in cross-section, such that its longest dimension in cross-section extends radially inward from the barrel.

In an embodiment, the rim is for a wheel suitable for a four-wheeled vehicle, such as an automobile, and first flange is an outboard flange. Accordingly, there is also provided a wheel for a four-wheeled vehicle, such as an automobile, and first flange is an outboard flange. If a third flange is present, it may be located closer to the first flange than the second flange (as measured along an axial direction).

In an embodiment, the rim is for a wheel suitable for a four-wheeled vehicle, such as an automobile, and first flange is an inboard flange. Accordingly, there is also provided a wheel for a four-wheeled vehicle, such as an automobile, and first flange is an inboard flange. If a third flange is present, it may be located closer to the second flange than the first flange (as measured along an axial direction).

In an embodiment, the rim is for a wheel suitable for a two-wheeled vehicle, which may be a motorised vehicle, such as a motorbike. In an embodiment, the rim is for a wheel suitable for a two-wheeled vehicle, which may be a non-motorised vehicle, such as a bicycle. If a third flange is present, it may be located approximately equidistant between the first flange and the second flange, as measured along an axial direction.

In an embodiment, e.g. in a two-wheeled vehicle, the first flange and second flange have the same description as one another. In an embodiment, e.g. in a two-wheeled vehicle, the first flange and the second flange are substantially symmetrical versions of one another.

### Wheel

There is also provided a wheel comprising a rim as described herein. The wheel may further comprise spokes. The spokes may be integrally formed with the rim, which is sometimes termed a monobloc moulded wheel. In another embodiment, the spokes are not integrally formed with the rim, and may be fastened to the rim, for example by means of the third flange as described herein, or by means of a fastener, e.g. nut and/or bolt, that is located in the insert, such that the fastener and or spoke to which it is attached, extends through the structural fibres of the barrel.

The wheel may be a MonoBloc wheel or a multi-piece Hybrid wheel.

There is also provided a vehicle comprising a wheel as described herein.

### Method of Making the Rim

There is also provided a method of making a rim as described herein, the method comprising assembling the structural fibres and the pre-formed insert(s), and binding them together by the polymer matrix, to form the wheel described in the first aspect. This may involve assembling the various components, i.e. the structural fibres and the pre-formed insert(s) in a mould and then bonding them together in a polymer matrix. The layers of structural fibres, which may be in the form of fabrics, may be pre-impregnated with resin or precursor material that will polymerise to form a resin, and then cured in a mould to form the rim, optionally with spokes, if forming a monoblock or hybrid wheel. In an alternative embodiment, the various components are assembled in a mould and a resin (or precursor material for making the resin) applied, either as they are assembled (e.g. in a wet lay-up process or pre-preg process) or after the mould is closed (e.g. in the resin transfer moulding technique) and the polymer cured to form the polymer matrix and to bind the components together. In an embodiment with a third flange, spokes may be attached to the third flange to form the wheel. In an embodiment, a plurality of apertures are made in the third flange, e.g. each aperture extending axially through the third flange, to which the spokes are attached, e.g. by a portion of the spoke or a fastener to the spoke extending through each aperture.

In an embodiment, the method involves injection moulding a material to form the insert before assembling the insert with the structural fibres.

Non-limited embodiments of the present invention will now be described with reference to the Figures. An individual feature mentioned below may be combined individually, and without reference to any associated features, with any of the aspects described here or other optional and preferred features described herein.

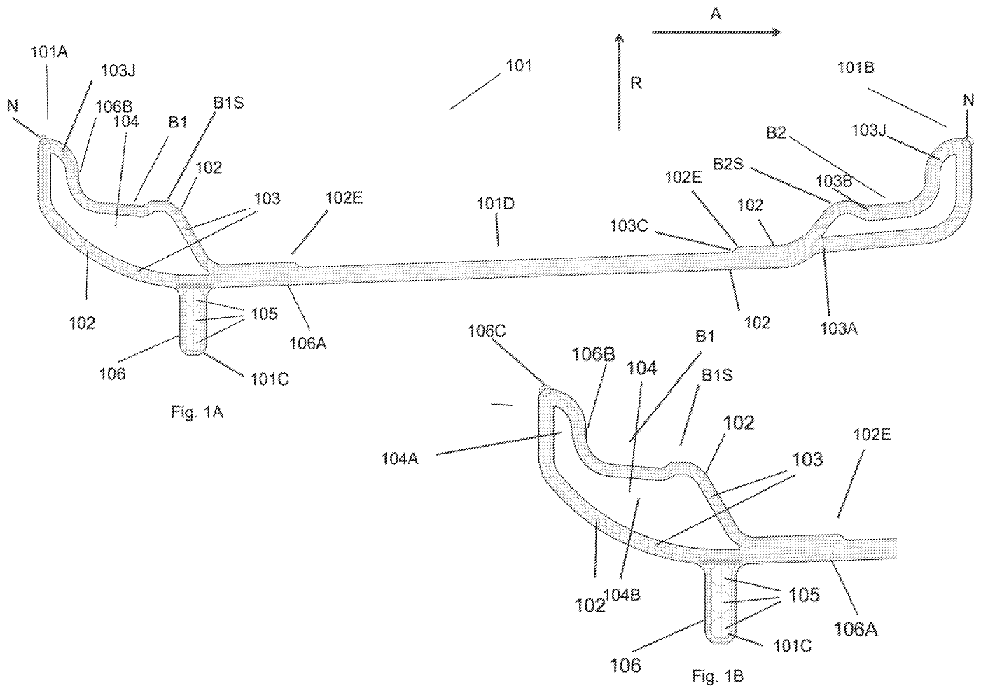

FIG. 1A shows a cross sectional view of an embodiment of the rim 1 for use in a wheel on a four-wheeled vehicle. In this embodiment, the rim 101 is shown in cross section. A first flange 101A constitutes an outboard flange of the rim, i.e. the flange that would be outermost when the wheel is installed on a four-wheeled vehicle. A second flange 101B constitutes an inboard flange, i.e. the flange that would be innermost when the wheel is installed on a four-wheeled vehicle. A first bead seat B1 is arranged axially inward of the first flange 101A. A second bead seat B2 is arranged axially inward of the second flange 101B.

A primary structural component 103, formed by a plurality, e.g. at least two layer, optionally at least three, optionally at least four layers of, tri-axial fibre that extend through the first flange 101A, the barrel 101D, and the second flange 101B. The primary structural component is capable of bearing the majority of the radial and/or lateral load that, in use, would be borne by the rim. The primary structural component is a balanced lay-up, in that the ratio of thickness of the first plurality of layers of structural fibres in the primary structural component to the second plurality of layers of structural fibres is from about 2:1 to about 1:2 and may be about 1:1. The primary structural component may be considered to be the component having layers of fabric that extend at least part way around the contour of the first flange, all along the barrel, and at least part way around the contour of the second flange and/or have at least some structural fibres running parallel to the axial direction of the rim.

An outer layer (102) comprising two layers of plain weave biaxial carbon fibre material is disposed on the primary structural component.

A protective insert 104 is disposed between disposed between layers of the tri-axial structural fibres 103. As seen in FIGS. 1A and 1B, when viewed in cross-section (with the axis of the rim being parallel to the plane of the cross-section), the insert has two elongate portions, with a first elongate portion (104A) of the insert extending the first flange (in this case, the outboard flange), and a second elongate portion (104B) of the insert extending underneath the first bead seat (B1), respectively, such that first and second portions together form an approximate ‘L’ shape in cross-section. The second elongate portion of the insert extends underneath the first bead seat, and a first safety bead (B1S), i.e. a raised portion relative to the flat portion of the beat seat, is located axially inwardly of the first bead seat, and the insert approximately follows the outer contour of the first bead seat and first safety bead. This has been found advantageous over previous designs of rim, since the safety bead would otherwise need to be made from increased thickness of carbon fibres, unidirectional structural fibres (e.g. a braided cord), or increased amount of resin, which adds to manufacturing complexity, cost and potentially introduces points of weakness into the rim. As shown in the Examples below, a rim according to the disclosure performs comparably well as predecessor designs, yet is far more straightforward to manufacture. In the embodiments shown in the Figures, the protective insert 104 comprises a foam, which may be a closed or open-cell foam, formed from a suitable material such as injection-moulded polyurethane foam. Compression moulded foams could also be used. The use of moulded foams was found to be an improvement over foams that require tooling, e.g. machining or milling, into the desired shape (i.e. the foams are not formed in the desired shape and so need to be cut or otherwise fashioned such that they are the desired shape). Using moulded foams avoided waste, and allowed a more complex shape to be made more economically. Moulded foams also have a skin on them, which cut foams do not typically have. This was found to have a number of advantages in that it makes the foam stiffer and seals it from resin ingress during the manufacture of the rim-resin ingress into the insert can be undesirable as it can add weight to the rim with no structural benefit. This, in combination with the use of triaxial fabrics, particularly on the upper part of the bead seat, and the balanced lay-up, provided a rim that performed surprisingly well in mechanical tests.

The rim shown in FIGS. 1A and 1B comprises a third flange 101C. The third flange extends from the barrel radially inwardly (i.e. toward the axis of the rim) and to which wheel attachments, e.g. spokes, may be fitted. This flange may be termed a mounting flange, since it can be used to mount the rim to spokes (to form a wheel) and thereby to an axel. The third flange is formed by further layers of structural fibres (106) that follow the contours of the third flange and extend along a radially inner side of a barrel on both sides of the third flange, such that it extends along an axially outer edge of the first flange. The further layers of structural fibres comprise tri-axial fabric. This additional layer of structural fibres was found to be important in maintain structural integrity of the rim in the demanding mechanical tests (e.g. those described in the Examples below).

The third flange may extend all the way around the circumference of the rim.

The third flange has a plurality of apertures (not shown) extending axially therethrough, i.e. in the direction of the axes of the wheel. Spokes can be fitted to the rim by virtue of the apertures.

The third flange has disposed therein three filling components (105), each of which runs at least part way around the circumference of the rim. The filling components are disposed concentrically, with respect to the axis of the rim. The filling component comprises a substantially unidirectional fibrous material extending in a circumferential direction around the rim. The fibrous material is braided together forming a rope. This may be termed a noodle herein. The fibrous material may comprises carbon fibres. Braided carbon fibre noodles are available commercially, for example from Cristex®. Alternatively, an insert that is elongate in cross-section may be included, with the longest dimension, when viewed in cross-section, extending radially inward from the barrel.

In FIG. 1A the first flange (101A; here, the outboard flange) and second flange (101B; here, the inboard flange), and first and second inserts, are very similar to one another, except that the second insert has a thinner second elongate portion, and there is no third flange extending from underneath the second bead seat.

The layer of carbon fibre materials (102, 103 and 106), and the protective insert 105 are bound together by a polymer matrix (polymer not shown in diagram, but would be present within and between the layers of fabric). The carbon fibre layers preferably comprise structural fibres impregnated by the polymer matrix, i.e. the primary structural component and the bead seats are fibre-reinforced plastics. The protective inserts may or may not have been impregnated with the polymer matrix, e.g. if they comprise a foam, depending on whether or not this is an open-celled or close-celled foam, they but are bound to the other components by the polymer matrix.

In this embodiment, the rim comprises an outer layer 102 also bound by the polymer matrix. The outer layer 102 extends over the entire inside of the barrel (i.e. the side closest to the axis of the rim), over each top outward edge of both the flanges 101A, 101B, and extends axially inward from each of the flanges to form, with the upper tri-axial fabric layer, the bead seats B1, B2, with the edge 102E of the outer layer finishing on the barrel 101D. In this embodiment, the outer layer 102 comprises structural fibres in the form of a biaxial fabric. Preferably, in this embodiment, the outer layer 102 and the primary structural component 103 each comprise a plurality of fabric layers comprising structural fibres, the primary structural component comprising a greater number of fabric layers than the outer layer, and the fabric layers of the primary structural component are substantially triaxial fabric.

The outer fabric may alternatively be a twill woven fabric or a braided fabric (not shown in figures).

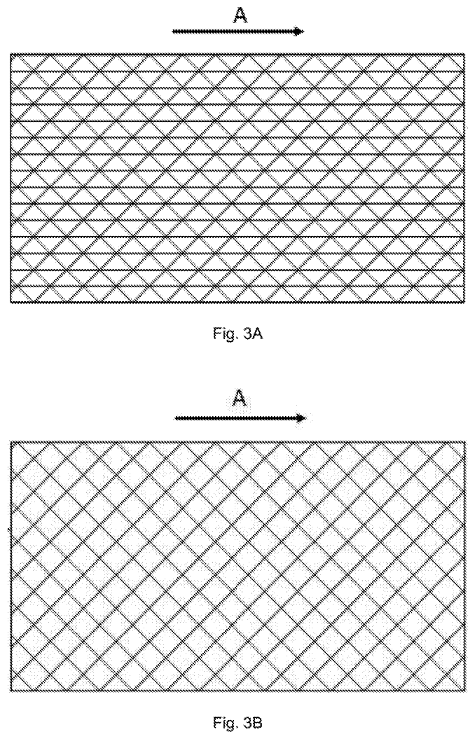

In the primary structural component 103 at least some of the structural fibres of the primary structural component extend through the primary structural component in a direction substantially parallel to an axis defined by the rim, when viewed from a radial direction R. In other words, at least some of the structural fibres extend through the rim from the first flange to the second flange along the shortest path between them (e.g. as shown in FIG. 3A schematically). In FIGS. 1A, and 1B, this would be in the same plane as the page, and along the lines shown in the first structural component. When the primary structural component comprises a biaxial or triaxial fabric, then the fabric is aligned such that one of the axes of the fibres extends along the flange-to-flange direction, i.e. along the axial direction A of the rim.

FIG. 3A shows, schematically, a triaxial fabric for use in the primary structural component 103, when viewed from a radial direction R, with one of the axes of the fibres of the fabric being parallel to the axial direction, i.e. running along a flange-to-flange direction (from the first flange to the second flange).

Preferably, the outer layer 102 substantially lacks fibres that extend through the outer layer in a direction substantially parallel to an axis defined by the rim, when viewed from a radial direction R. In other words, the outer layer substantially lacks fibres that extend from the first flange to the second flange along the shortest path between them. When the outer layer comprises a biaxial fabric, for example, the fabric is aligned so that neither the axes of the fibres are along a flange-to-flange direction. Each axis of the fibres is preferably aligned such that there is an angle of at least 30° between the flange-to-flange direction and either of the two axes of the fibres in the biaxial fabric. For example, the outer layer may be a biaxial fabric and the fibres are orientated at about +/−45° to the flange-to-flange direction.

In an embodiment, the primary structural component comprises at least one layer of structural fibres formed into a triaxial fabric and one of the axes of the fibres extends along the flange-to-flange direction, i.e. along the axial direction A of the rim, when viewed from a radial direction R, and the outer layer 102 comprises at least one layer of structural fibres formed into a biaxial fabric and aligned so that neither the axes of the fibres in the biaxial fabric are along a flange-to-flange direction, i.e. along the axial direction A of the rim, when viewed from a radial direction R.

FIG. 3B shows, schematically, a biaxial fabric for use in the outer layer, e.g. as part of the bead seat, when viewed from a radial direction, with neither of the axes of the fibres of the fabric being parallel to the axial direction, i.e. running along a flange-to-flange direction (from the first flange to the second flange). Each axis of the fabric is at an angle of about 45° to the flange-to-flange direction (or axial direction A).

As mentioned, preferably, the primary structural component comprises a triaxial fabric and the outer layer comprises a biaxial fabric and the axes of the fabric may be orientated as described above. The triaxial fabric may comprise structural fibres orientated in three directions, as described herein, and may optionally further include further fibres, e.g. structural fibres, in a fourth direction, which may be woven in with or sewn into the other fibres. This can aid the manufacturing process.

### EXAMPLES

### Production of the Rims

A test program was carried out on a number of wheels, each comprising (i) a rim according to the disclosure and (ii) a standard centrepiece.

A rim (101) according to the disclosure was tested-it had a cross section substantially as shown in FIG. 1A (the full rim) and FIG. 1B (a close-up of the outboard flange). In this rim the outer layer (102) comprised two layers of plain weave biaxial carbon fibre material, the primary structure component (103) comprised six layers of tri-axial carbon fibre material, in this case in a balanced layup, the inserts (104) comprise an injection moulded polyurethane and the unidirectional structural fibres (105) comprise braided carbon-fibre material. In this case, the primary structural component are fibres that extend axially along the whole of the barrel and fully envelope the inserts. The six layers of tri-axial fabric are in contact with one another in the barrel, but split around the inserts, such that there are three layers of triaxial fabric disposed on each side of the insert. Three of the six layers have an edge at 103J on the first flange and extend along the first bead seat, along the barrel, along the second bead seat and then have another edge at 103J on the second flange. The other three layers again have an edge at 103J in the first flange but extend in the opposite direction to the other three layers, so over the tip of the flange, along the axially outward edge of the flange, along the side of the barrel disposed closest to the axis and then over the axially outward edge of the second flange, with another edge at 103J in the second flange. The resin used to bind the carbon fibre fabrics together was an epoxy resin. The fibres in the primary structural component were oriented so that one of the axes of the fibres was aligned along the flange-to-flange direction A (as shown schematically in FIG. 3A). The fibres of the biaxial plain weave in the outer layer (103) were oriented so that both axes were at an angle of about 45 degrees to the flange-to-flange direction A (as shown schematically in FIG. 3B). Two additional reinforcement tapes of triaxial material (106) were wrapped around the outer flanges (and sandwiched between the biaxial fabrics), starting at point 106A and ending 106B, the outer reinforcement tape thereby extending around the mounting flange (i.e. the third flange), with unidirectional structural fibres (105) filling wrapped into the mounting flange as a filler (as shown in FIG. 1). The additional triaxial fabrics extending around the third flange were found to be important to minimise the risk of the third flange shearing off in various mechanical tests. The injection-moulded insert was found to be advantageous, as it had effectively a skin thereon, and that, together with the insert following the contour of the safety bead, reduced the need for unidirectional structural fibres running circumferentially around the rim (one purpose of the unidirectional structural fibres being to avoid a build-up of resin that can lead to structural weak points).

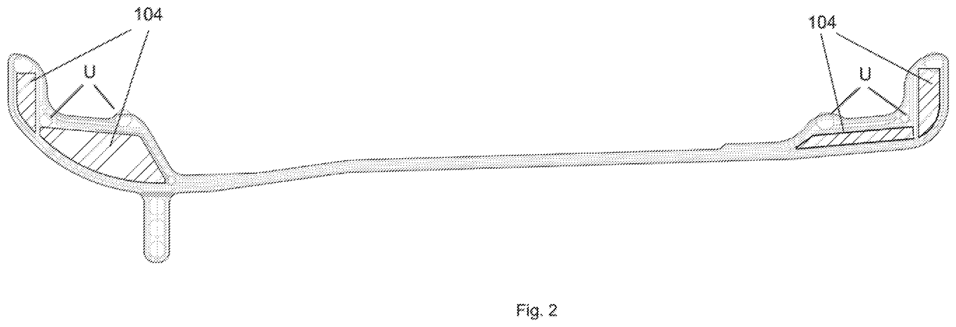

(In contrast, the former version, Mk2, as described herein, required two further unidirectional structural fibres—one in the safety bead, and another at the change in direction of the fabrics from the flat bead seat to the vertical part of the flange—these additional unidirectional structural fibres are denoted ‘U’ in FIG. 2.)

The foamed polyurethane had the following properties:

Density: 290 Kgm3 (as measured by BS4730)

Closed cell content: 98.9% (as measured by ASTM 0-6226)

Compressive Strength (parallel to rise): 3800 kPa (as measured by BS4730)

Skin hardness, Durometer—Shore A: 96; Shore D: 42

In the second flange (the inboard flange), the triaxial fabrics of the primary structural component (103) were, as in the first (outboard) flange, disposed closest to the insert. As mentioned, these completely envelope the second insert, the ends meeting at a point (103J) disposed axially inward of the tip of the insert (the tip being the point disposed radially furthest from the axis of the rim). Two further shorter triaxial fabrics are disposed around the second insert, with both having an end of the fabric starting at 103A, and then running axially outward and around the insert, with one of these triaxial fabrics having an end at 103B, and another at 103C (the same point that the biaxial fabrics end at 102E)

The outermost fabric in this embodiment is a woven biaxial fabric, but this could be triaxial, woven structure from 2 sets of yarns (e.g. in a plain weave or a twill) or a non-crimped fabric. It could also be a non-carbon material.

Tri-axial fabrics in the rim could be replaced by biaxial fabrics, but performance would be inferior.

The rim was manufactured by layering the dry carbon fibre onto a heated mandrel, starting with the plain weave biaxial carbon fibre (102), a carbon unidirectional braided fabric (N) was wound into the mounting flange. Next six layers of tri-axial carbon fibre fabric (103) and additional re-enforcement tapes of tri-axial carbon fibre fabric (106) were added. The plain weave and three of the layers of tri-axial carbon fibre fabric were pulled back to allow the inserts (104) and carbon unidirectional structural fibre (N) to be placed between them at the tip of each flange. The plain weave and half of (i.e. three layers of, in this case) the tri-axial carbon fibre fabrics were then wrapped back over the inserts to create the inner and outer flanges. This dry layup was then enclosed in an outer mould, comprising sections, and the cavity evacuated using a vacuum pump. The epoxy resin binder was then injected under increasing magnitudes of pressure to infuse and consolidate the material. This was left in the tool at 90° C. to cure, the partially cured part was then freed from the mould and completely cured in an oven for 3 hours ramping from room temperature to 180 degrees Celsius then held at 180 degrees Celsius for one hour before being allowed to cool. The cured component was hand and machine finished to remove flash and holes were drilled into the mounting flange. The rim was then abraded to key the surface and a protective lacquer was applied by spraying, this was allowed to cure at room temperature to achieve the finished surface properties.

The reduced manufacturing complexity reduces the cost to produce the carbon fibre rim (Mk3), compared to an a reference rim (denoted Mk2) having two inserts in each flange, and allows for development of semi-automated or automated manufacture. The process of wrapping back the carbon over the inserts is reduced in complexity increasing manufacturing reliability and reducing the time required. Significant reduction in the time required to form the dry material is achieved (at least 1 hour), reducing manufacturing labour costs.

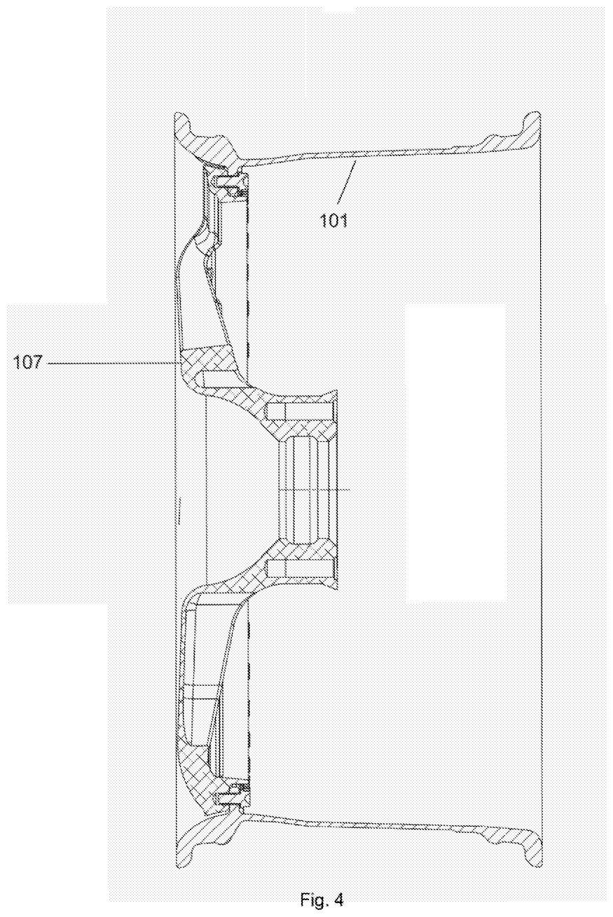

All tested wheel assemblies included a centrepiece as would be used with this size of rim as standard, assembled as shown in FIG. 4. The centrepiece selected was suitable to determine the carbon fibre rim's capability in actual service.

The insert material can be easily changed, allowing for lower cost materials to be used in the rim. The rim tested used a low cost polyurethane material as the insert, however substitution of this material would be easily possible without a change of tooling or altering the cross section described in FIG. 1. It would also be possible to substitute the material for one of much higher density or of a more structural material to achieve higher performance where mechanical efficiency is required over cost reduction. Substitution of this material would not require expensive tooling modifications and could be achieved using the same cross section, reducing the cost to produce and test variations of rim and maintaining the process used to create the cross section.

It would also be possible to switch between materials in the insert between individual rims, allowing the production line to switch production between different performing rims without the need to change out tooling.

### Testing the Rims

The tests carried out are described in the following paragraphs, these tests were similar to prior test programs to allow comparison to reference rims with cross section schematically as shown in FIG. 2 (denoted Mk2 design below) The Mk2 design was broadly representative of the rims described in the applicant's previous patent application, WO2017/046555, e.g. FIGS. 1, 2 and 3A, i.e. in which a primary load path, formed by trixaxial carbon fibre fabric passes between the two inserts in each flange.

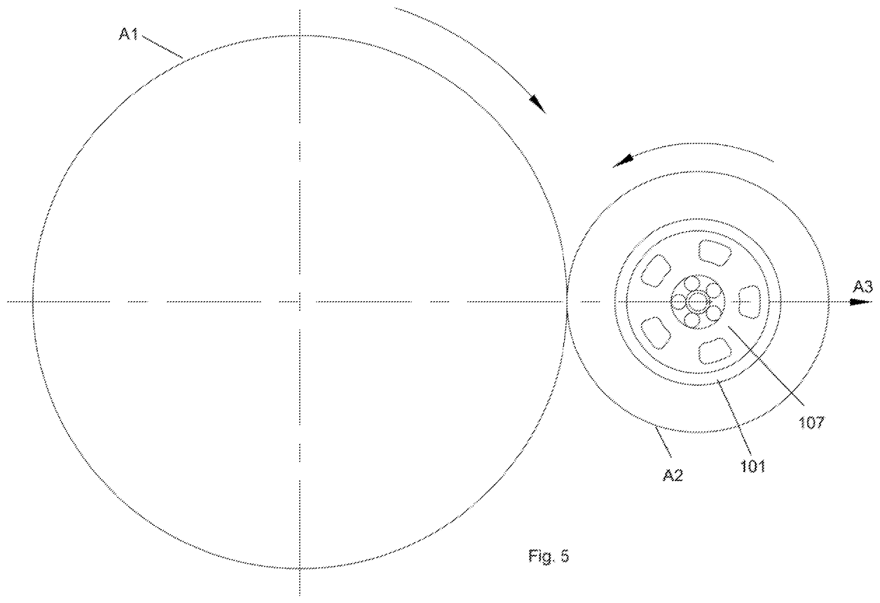

A radial load test was carried out on a wheel, comprising a rim (101) according to the disclosure and standard centrepiece (107, as shown in FIG. 4). A schematic illustration of the test equipment is shown in FIG. 5. The test comprises a driven drum A1 on which the test wheel is mounted under radial load, as shown in FIG. 5; this type of test is normally referred to as a radial fatigue test. In this Figure, the driven drum is denoted A1, the wheel being tested denoted A2, the rim of the wheel denoted 101, the spokes of the wheel denoted 107 and the radial load by an arrow A3. The number of wheel revolutions before failure, defined as the point of tyre deflation or wheel breaking, is recorded. The described test was undertaken in accordance with SAE J2530.

The radial test loads were set at 640 kg a typical load for vehicles using this size of wheel. An accelerated test factor of 2.5 was multiplied onto each wheel rating to calculate the total applied test load. The testing ran to 1,100,000 cycles. The wheel passed the test, showing no damage in the rim upon visual inspection and retaining the initial tyre pressure. The test was terminated as the result was deemed sufficient, though the undamaged state of the wheel suggests if could have withstood a heavier or longer lasting test.

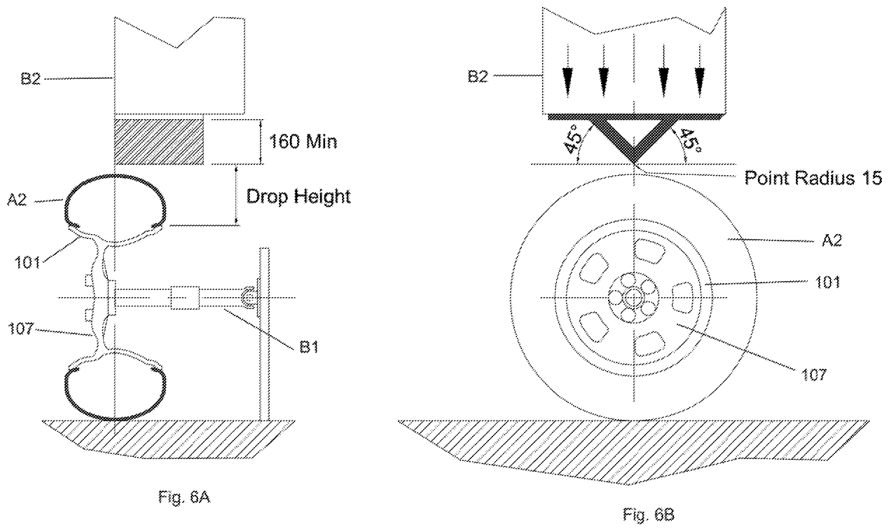

A 90 degree (radial) impact test was carried out on a wheel, comprising a rim according to the disclosure and standard centrepiece. A schematic illustration of the test equipment is shown in FIGS. 6A (showing a cross-sectional view of the wheel) and 6B (showing a view from the same direction as the axis of the wheel). The test comprises an angled fixture onto which the test wheel is mounted with the tyre touching the ground a drop mass is released from a set height to impart impact energy into the tyre side of the rim as shown in FIGS. 6A and 6B. This type of test is normally referred to as a 90 degree impact test. In this figure the fixture is denoted B1, the wheel being tested denoted A2, the rim of the wheel denoted 101, the spokes of the wheel denoted 107 and the drop mass denoted by B2. An assessment of the damage caused by impact is undertaken, the tyre is required to not entirely loose pressure for one minute after impact, the rim is required to have permanent deformation less than 6 mm. The described test was undertaken in accordance with the ford impact specification. Results are shown in Table A below.

The drop mass was set to a height of 186 mm and mass of 564 kg to give an equivalent static impact load of 640 kg. The wheel passed the test, holding air for over one minute, showing typical damage to the rim and having 4 mm permanent deformation. The damage was in the same order as Mk2 rims testing at similar loads.

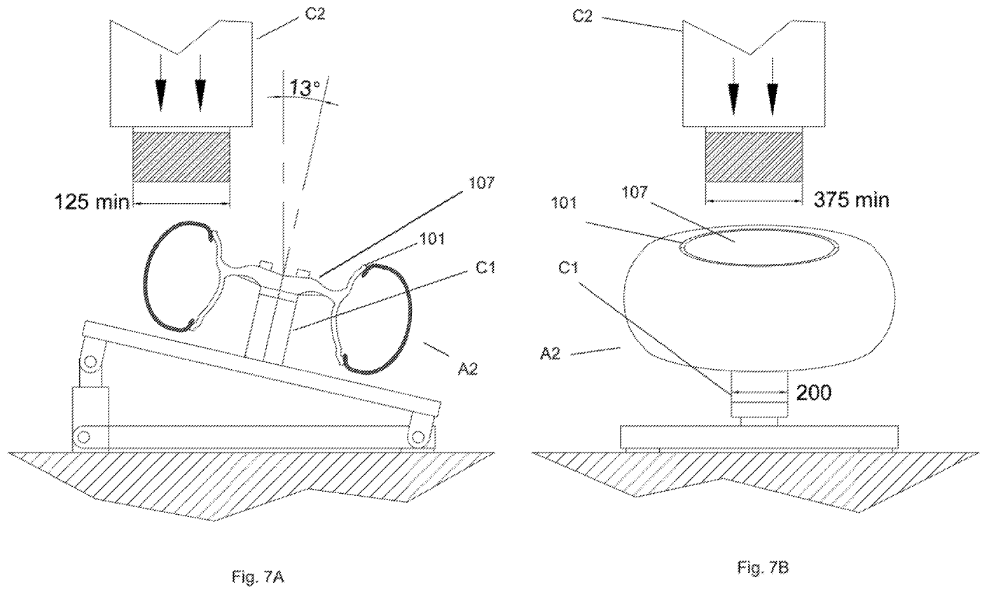

A 13 degree (lateral) impact test was carried out on a wheel, comprising a rim according to the disclosure and standard centrepiece. The test comprises an angled fixture onto which the test wheel is mounted, a drop mass is released from a set height to impart impact energy into the side of the rim as shown in FIGS. 7A (showing a cross-section of the wheel) and 7B (shown at 90 degrees from FIG. 7A, i.e. from right hand side of FIG. 7A). This type of test is normally referred to as a 13 degree impact test. In this figure the fixture is denoted C1, the wheel being tested denoted A2, the rim of the wheel denoted 101, the spokes of the wheel denoted 107 and the drop mass denoted by C2. An assessment of the damage caused by impact is undertaken, the tyre is required to not entirely loose pressure for one minute after impact, the rim is required to not have a crack fully through the section, the centrepiece is required to not separate from the rim and the centrepiece is required to not have any cracks. The described test was undertaken in accordance with SAE J175.

The drop mass was set to a height of 230 mm and mass of 564 kg to give an equivalent static impact load of 640 kg. Two strikes were made, one at the valve hole and one across the spokes as 180 degrees to the valve hole. The wheel passed both tests, holding air for over one minute, showing no cracks in the rim or centrepiece and no separation of the centrepiece from the rim.

The carbon fibre rim design (Mk3) described herein shows comparable test performance to a previous carbon fibre rim design (Mk2) of similar cross section. There was also found to be advantages in maintaining the fatigue life of the wheel. With the load path running beneath the bead seat, and being split in a balanced lay-up, this was found to distribute the forces from the tyre more evenly through the structure, removing stress concentrations at the interface between the bead seat and the tyre well.

The new (Mk3) rim was found to be faster to lay-up compared to the Mk2 rim, when constructing them manually, and the human operatives require less training. It also allows the rim to be constructed in an automated way more easily. It was also found that the resin that forms the polymer matrix injects more quickly and consistently into the layers of structural fibres in Mk3 rim compared to the Mk2 rim—this leads to fewer problems overall when mass-producing the wheels, and a generally higher quality of each rim. The Mk3 rim also gave fewer problems with surface porosity on the tyre-mounting surface (the bead seat), and significantly less surface finishing work prior to lacquer, compared to the Mk2 rim.

Reproduced below in Table A are test results for the 90 degree (radial) load test for Mk2 and Mk3 rim designs. Ford inner rim impact testing was conducted on both Mk3 and Mk2 rims of the same size, 21 inch diameter and 12.5 inch.

Table A shows summary details for the testing, showing loads and results.

TABLE A
comparative test results of Mk3 and Mk2 rims

| | Barrel | Static | Test load | Drop Height | | |
|---|---|---|---|---|---|---|
| Test ID | Type | load (kg) | (kg) | (mm) | Result | Notes |
| I-0791 | Mk2 | 640 | 561 | 186.00 | Pass | Wheel impacted 2 locations 2 |
| | | | | | | loads, valve hole +0, 180 + 80 |
| | | | | | | slight delamination inner flange |
| I-1397 | Mk2 | 850 | 690 | 212.09 | Fail | deformation = 7 mm, 10 mm |
| | | | | | | crack @ impact location. Wheel |
| | | | | | | was more oval in shape after hit |
| | | | | | | contributing to deformation. |
| I-1924 | Mk3 | 640 | 561 | 186.00 | Pass | No cracks. Deformation <1 mm. |
| I-1935 | Mk3 | 850 | 690 | 212.09 | Pass | No cracks. Deformation ~1 mm. |
| I-1936 | Mk3 | 1000 | 780 | 230.12 | Pass | Cracks at impact location in inner |
| | | | | | | flange ~65 mm in length. |
| | | | | | | Deformation ~2 mm. |

The testing showed a significant improvement in the rims performance between the Mk2 and Mk3 designs. At 850 kg static test load the Mk2 rim did not pass the 90 degree (radial) impact test, the Mk3 rim passed this test and a further test with a further increase in static test load to 1000 kg.

1. A rim for a wheel, the rim comprising
a barrel having first and second flanges extending radially outward from opposing edges of the barrel, and the barrel comprising a first bead seat and a second bead seat arranged axially inwardly, respectively, of the first and second flanges,
wherein the barrel, and first and second flanges, comprise layers of structural fibres bound in a polymer matrix,
wherein a pre-formed insert is disposed between layers of the structural fibres, wherein the insert comprises a material which acts to absorb and/or deflect and/or dissipate energy from a load or impact applied axially and/or radially to a rim and/or acts to increase the hoop stiffness of the wheel and wherein the insert has, when viewed in cross-section (with the axis of the rim being parallel to the plane of the cross-section), two elongate portions, with a first elongate portion of the insert extending into one of the first or second flanges, and a second elongate portion of the insert extending underneath the first or second bead seat, respectively, such that first and second portions together form an approximate ‘L’ shape in cross-section.

2. A rim for a wheel according to claim 1, wherein a first plurality of layers of structural fibres form the bead seat above (i.e. radially outward of) the second elongate portion of the insert, and a second plurality of layers of structural fibres are disposed below (i.e. radially inward of) the second elongate portion and wherein the ratio of thickness of the first plurality of layers of structural fibres to the second plurality of layers of structural fibres is from about 2:1 to about 1:2, optionally about 3:2 to about 2:3, optionally about 4:3 to about 3:4, optionally about 5:4 to about 4:5.

3. A rim for a wheel according to claim 2, wherein a second plurality of layers of structural fibres is the of the same or greater thickness than the thickness of the first plurality of layers.

4. A rim for a wheel according to any one of the preceding claims, wherein the pre-formed insert comprises or consists of a material selected from a compressible material, an elastomeric material and a cellular material.

5. A rim for a wheel according to claim 4, wherein the cellular material is an injection-moulded foam material.

6. A rim for a wheel according to any one of claims 1 to 3, wherein the pre-formed insert comprises or consists of a hollow shell that forms the insert, optionally wherein the hollow shell is formed from a rigid material, optionally wherein the rigid material is selected from a metal, a plastic and compression moulded carbon fibre, optionally wherein the metal is aluminum.

7. A rim for a wheel according to any one of the preceding claims, wherein first and second flanges each contain an insert as defined in claim 1, with a first insert having its first elongate portion extending into the first flange and its second elongate portion extending under the first bead seat, and a second insert having its first elongate portion extending into the second flange and its second elongate portion extending under the second bead seat.

8. A rim for a wheel according to any one of the preceding claims, wherein the rim is for a wheel for a four-wheeled vehicle, with the first flange being an outboard flange, when fitted to a vehicle, and the first elongate portion of the insert extending into one of the first flange, and the second elongate portion of the insert extending underneath the first bead seat.

9. A rim for a wheel according to any one of the preceding claims, wherein the first elongate portion of the insert extends into one of the first flange, and the second elongate portion of the insert extending underneath the first bead seat, and a first safety bead is located axially inwardly of the first bead seat, and the insert approximately follows the outer contour of the first bead seat and first safety bead.

10. A rim for a wheel according to any one of the preceding claims, wherein the rim comprises a third flange that extends from the barrel radially inwardly and to which wheel attachments, e.g. spokes, may be fitted, wherein the third flange is formed by further layers of structural fibres that follow the contours of the third flange and extend along a radially inner side of a barrel on both sides of the third flange, optionally such that it extends along an axially outer edge of a flange, which may be the first flange if the third flange is located on the same side of the barrel as the first flange.

11. A rim for a wheel according to claim 10, wherein the further layers of structural fibres comprise tri-axial fabric.

12. A wheel comprising a rim according to any one of claims 1 to 11.

13. A vehicle comprising a wheel according to claim 12.

14. A method of making a rim according to any one of claims 1 to 11, the method comprising assembling the structural fibres and the pre-formed insert, and binding them together by the polymer matrix, to form the rim.

15. A method according to claim 14, wherein the method involves moulding a material to form the insert before assembling the insert with the structural fibres, optionally wherein the moulding is injection moulding or compression moulding.
